(19) United States
(12) Patent Application Publication
(10) Pub. No.: US 2008/0235438 A1
(43) Pub. Date: Sep. 25, 2008

(54) System and method for effectively implementing a multiple-channel memory architecture

(75) Inventor: Yong Zhang, Poway, CA (US)

Correspondence Address: Gregory J. Koerner;Redwood Patent Law, 1291 East Hillsdale Boulevard, Suite 205, Foster City, CA, 94404, US

(73) Assignee: Sony Corporation and Sony Electronics Inc.

(21) Appl. No.: 11/725,726

(22) Filed: Mar. 20, 2007

(51) Int. Cl. G06F 12/00; G06F 1/04

(52) U.S. Cl. 711/103; 713/501

(57) ABSTRACT

A system and method for implementing a multiple-channel memory architecture includes a plurality of memory channels that are configured in a parallel manner to store electronic data. In certain embodiments, the memory channels are implemented to include non-volatile flash memory devices. A transfer controller communicates with the memory channels to control concurrent data transfer operations for transferring the electronic data in and out of the memory channels. The transfer controller generates individual channel clock signals to the respective memory channels for triggering corresponding data transfer operations which occur in an overlapping temporal sequence.

### BACKGROUND SECTION

1. Field of the Invention

This invention relates generally to techniques for implementing memory systems, and relates more particularly to a system and method for effectively implementing a multiple-channel memory architecture.

2. Description of the Background Art

Implementing effective methods for implementing electronic memory systems is a significant consideration for designers and manufacturers of contemporary electronic systems. However, effectively implementing memory systems may create substantial challenges for system designers. For example, enhanced demands for increased system functionality and performance may require more system memory and require additional hardware resources. An increase in memory or hardware requirements may also result in a corresponding detrimental economic impact due to increased production costs and operational inefficiencies.

Furthermore, enhanced system capability to perform various advanced storage operations may provide additional benefits to a system user, but may also place increased demands on the control and management of various system components. For example, an enhanced electronic system that effectively stores video image data may benefit from an efficient implementation because of the large amount and complexity of the digital data involved.

Due to growing demands on system resources and substantially increasing data magnitudes, it is apparent that developing new techniques for implementing and utilizing memory systems is a matter of concern for related electronic technologies. Therefore, for all the foregoing reasons, developing effective systems for implementing and utilizing electronic memory systems remains a significant consideration for designers, manufacturers, and users of contemporary electronic systems.

### SUMMARY

In accordance with the present invention, a system and method are disclosed for effectively implementing a multiple-channel memory architecture. In certain embodiment of the present invention, a memory subsystem of a data acquisition/playback machine includes a plurality of memory channels that may be implemented to include flash memory devices. Flash memory possesses certain distinct advantages over more conventional Dynamic Random-Access Memory (DRAM) devices.

For example, flash memory typically has a significantly higher density of memory storage space per given memory device. Furthermore, refresh operations are not required to provide data retention in flash memory, since flash memory is non-volatile. In addition, flash memory requires a significantly lower number of connection pins because flash memory does not utilize additional address pins, like in convention memory integrated circuits. In flash memory, all data and address accesses timely share the same physical connection pins. However, flash memory has one significant disadvantage because transfer speeds for data transfer operations to and from a flash memory device are relatively slow and time-consuming.

In accordance with one embodiment of the present invention, a central-processing unit (CPU) of an acquisition/playback machine initially receives an input data signal from any appropriate data source. The CPU provides the received input data to a memory subsystem that includes a transfer controller and two or more individual memory channels that are configured in a parallel manner. In various embodiments, any desired number of memory channels may be selected for optimal performance. The transfer controller initially writes the input data into the memory channels as stored data on a sequentially rotating page-by-page basis. The transfer controller may subsequently read the stored data from the plurality of memory channels in a similar manner, and then provide the stored data to an output FIFO as output data. The output FIFO may transmit the output data through a digital-to-analog converter (DAC) as an output data signal to any appropriate data destination.

Because of the foregoing multiple-memory architecture and corresponding control operations by the transfer controller, the present invention advantageously compensates for the relatively slow transfer times of flash memory, while benefiting from flash memory's many significant advantages. The present invention concurrently operates the multiple memory channels in a parallel manner to significantly increase data transfer speeds. The present invention thus provides an improved memory architecture in which the individual memory channels may be concurrently utilized to transfer data in a temporally-overlapping manner to significantly increase data transfer speeds of corresponding data transfer operations. For all the foregoing reasons, the present invention therefore provides an improved system and method for effectively implementing a multiple-channel memory architecture.

### BRIEF DESCRIPTION OF THE DRAWINGS

FIG. 1 is a block diagram of an electronic system, in accordance with one embodiment of the present invention;

FIG. 2 is a block diagram for one embodiment of the electronic device of FIG. 1, in accordance with the present invention;

FIG. 3 is a block diagram illustrating the operation of flash memory, in accordance with one embodiment of the present invention;

FIG. 4 is a timing diagram of an exemplary data transfer cycle, in accordance with one embodiment of the present invention;

FIG. 5 is a block diagram for one embodiment of the memory subsystem from FIG. 2, in accordance with the present invention;

FIG. 6 is a timing diagram for the clock signals of FIG. 5, in accordance with one embodiment of the present invention;

FIG. 7 is a timing diagram illustrating the operation of the FIG. 5 memory subsystem, in accordance with one embodiment of the present invention;

FIG. 8 is a block diagram for one embodiment of the memory subsystem from FIG. 2, in accordance with the present invention; and

FIG. 9 is a block diagram for one embodiment of the memory subsystem from FIG. 2, in accordance with the present invention.

### DETAILED DESCRIPTION

The present invention relates to an improvement in electronic memory architectures. The following description is presented to enable one of ordinary skill in the art to make and use the invention, and is provided in the context of a patent application and its requirements. Various modifications to the disclosed embodiments will be readily apparent to those skilled in the art, and the generic principles herein may be applied to other embodiments. Thus, the present invention is not intended to be limited to the embodiments shown, but is to be accorded the widest scope consistent with the principles and features described herein.

The present invention is described herein as a system and method for effectively implementing a multiple-channel memory architecture, and may include a plurality of memory channels that are configured in a parallel manner to store electronic data. In certain embodiments, the memory channels are implemented to include non-volatile flash memory devices. A transfer controller communicates with the memory channels to control concurrent data transfer operations for transferring the electronic data to or from the memory channels. The transfer controller generates individual channel clock signals to the respective memory channels for triggering corresponding data transfer operations which typically occur in an overlapping temporal sequence.

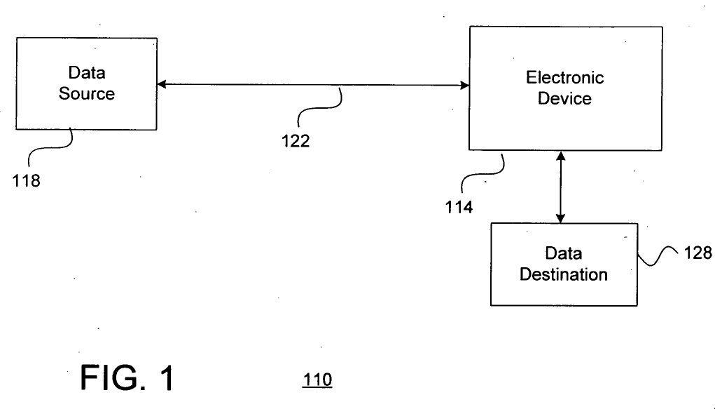

Referring now to FIG. 1, a block diagram of an electronic system 110 is shown, in accordance with one embodiment of the present invention. In the FIG. 1 embodiment, electronic system 110 may include, but is not limited to, an electronic device 114, a data source 118, and a data destination 128. In alternate embodiments, electronic system 110 may readily be implemented using various components and configurations in addition to, or instead of, those discussed in conjunction with the FIG. 1 embodiment.

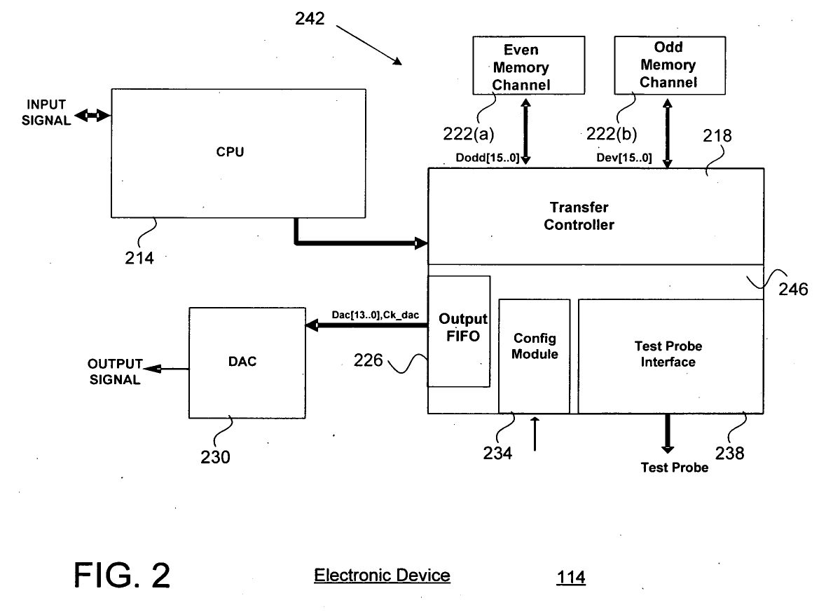

In the FIG. 1 embodiment, electronic device 114 may be implemented as any electronic device that is configured to receive and store electronic data or other information, and then supply the stored electronic data to data destination 128. In the FIG. 1 embodiment, the electronic data may include any desired types of electronic information in any appropriate format. Similarly, data source 118 may be implemented as any desired type of electronic information source. For example, in certain embodiments, data source 118 may include a television transmission system that provides radio-frequency television broadcast signals to electronic device 114. Electronic device 114 may responsively convert the radio-frequency television broadcast signals into a digital format before storing the digitized television signals. In the FIG. 1 embodiment, data destination 128 may be implemented as any desired type of entity. For example, in certain embodiments, data destination 128 may include, but is not limited to, a data diagnostics system for accessing and analyzing the electronic information stored in electronic device 114. The implementation and utilization of electronic device 114 is further discussed below in conjunction with FIGS. 2-9.

Referring now to FIG. 2, a block diagram for one embodiment of the FIG. 1 electronic device 114 is shown, in accordance with the present invention. In alternate embodiments, electronic device 114 may be implemented using various components and configurations in addition to, or instead of, certain of those components and configurations discussed in conjunction with the FIG. 2 embodiment. In addition, electronic device 114 may be implemented as any appropriate type of electronic device or system. For example, in certain embodiments, electronic device 114 may be implemented as a data acquisition/playback machine.

In the FIG. 2 embodiment, a central-processing unit (CPU) 214 receives an input data signal from any appropriate data source 118 (FIG. 1). CPU 214 may be implemented to include any effective and compatible microprocessor device that preferably executes software instructions to control and manage the operations of electronic device 114. In the FIG. 2 embodiment, CPU 214 provides the received input data to a memory subsystem 242 that includes a memory controller module 246 and at least two memory channels 222.

In the FIG. 2 embodiment, memory controller module 246 includes a transfer controller 218, an output first-in first-out memory (output FIFO) 226, a configuration module 234, and a test probe interface 238. In the FIG. 2 embodiment, memory channels 222 include an even memory channel 222(a) and an odd memory channel 222(b). In various other embodiments, any desired number of memory channels 222 may alternately be utilized. In the FIG. 2 embodiment, transfer controller 218 writes the input data into the memory channels 222 as stored data.

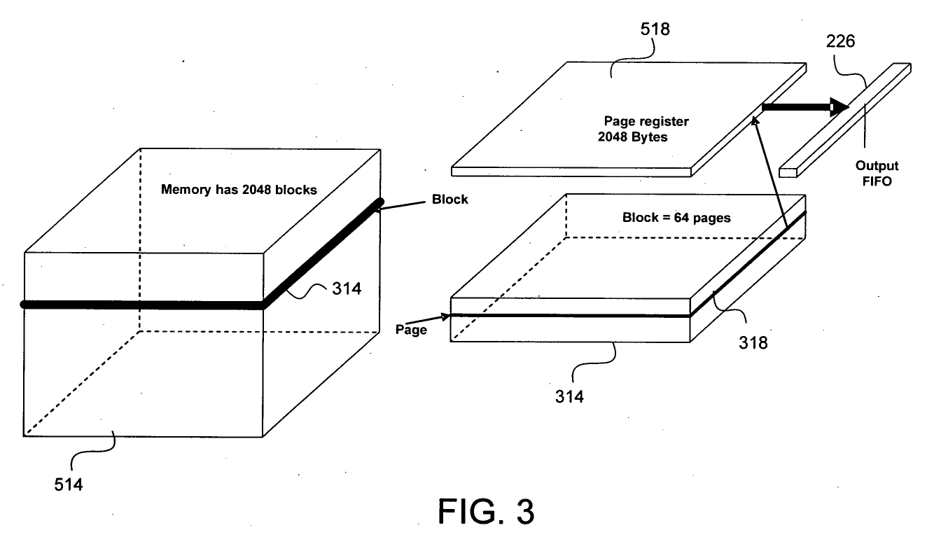

In the FIG. 2 embodiment, transfer controller 218 may subsequently read the stored data from memory channels 222 and provide stored data to output FIFO 226 as output data. Output FIFO 226 may then transmit the output data through digital-to-analog converter (DAC) 230 as an output data signal to any appropriate data destination 128 (FIG. 1). In the FIG. 2 embodiment, a test probe may connect to memory controller 246 through a test probe interface 238 for perform any desired types of diagnostic procedures. In addition, memory controller module 246 may be configured by any appropriate external entity through configuration module 234. The implementation and utilization of the FIG. 2 memory subsystem 242 is further discussed below in conjunction with FIGS. 3-9.

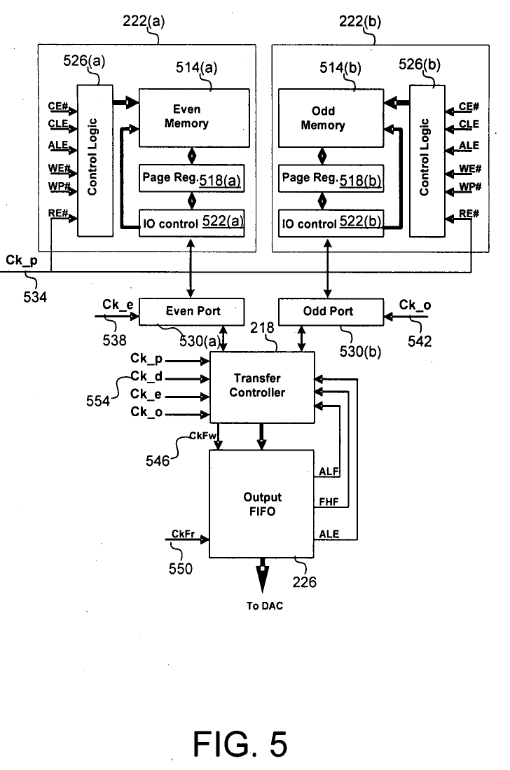

Referring now to FIG. 3, a block diagram illustrating the operation of flash memory 514 is shown, in accordance with one embodiment of the present invention. The FIG. 5 embodiment is presented for purposes of illustration, and in alternate embodiments, flash memory 514 may utilize various techniques and configurations in addition to, or instead of, certain of those techniques and configurations discussed in conjunction with the FIG. 3 embodiment.

In accordance with certain embodiments of the present invention, the FIG. 2 memory channels 222 of electronic device 114 may be implemented to include multiple data storage memories that are configured to include conventional or enhanced flash memory devices 514. Flash memory 514 is a known type of constantly-powered non-volatile memory that can be erased and reprogrammed. Flash memory 514 possesses certain distinct advantages over more conventional Dynamic Random-Access Memory (DRAM) devices.

For example, flash memory 514 has a higher density of memory space per device. Furthermore, refresh operations are not required for data retention since flash memory 514 is non-volatile. Power requirements are therefore less than DRAM devices. In addition, flash memory 514 requires a significantly lower number of connection pins because flash memory 514 does not utilize address pins and utilizes fewer control pins. This reduction in pin count is a significant benefit in designing corresponding integrated circuits. However, flash memory 514 has one significant disadvantage because access speeds for data transfer operations to and from flash memory 514 are relatively slow. The present invention therefore provides a multiple-channel memory architecture to advantageously increase data throughput in data transfer operations.

In the FIG. 3 embodiment, a flash memory device 514 is shown with 2048 blocks 314 of data. A block 314 of data is also shown with 64 pages 318 of data. During certain data transfer operations, pages 318 of data are first loaded into an internal page register 518 before being transferred to an output FIFO 226 (FIG. 2). The implementation and utilization of memory channels 222 (FIG. 2) are further discussed below in conjunction with FIGS. 5 through 9.

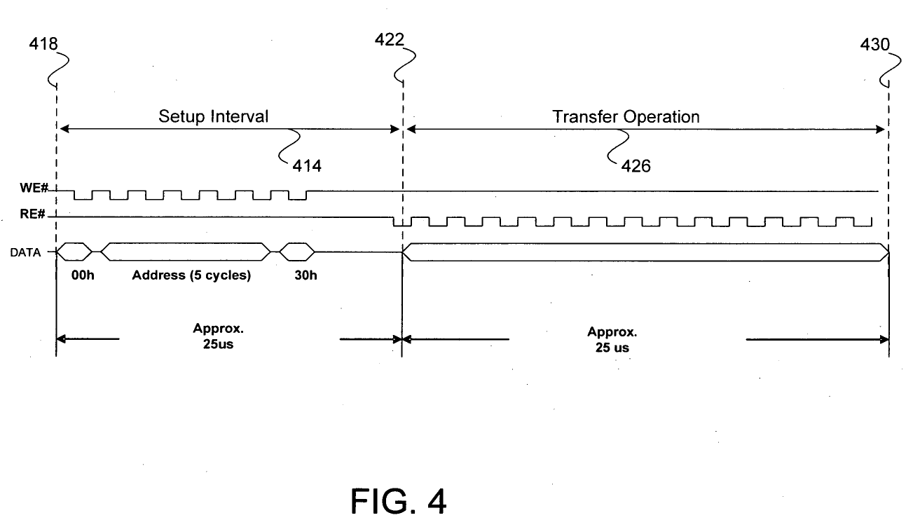

Referring now to FIG. 4, a timing diagram of an exemplary data transfer cycle is shown, in accordance with one embodiment of the present invention. The FIG. 4 example is presented for purposes of illustration, and in alternate embodiments, the present invention may utilize data transfers cycles with timings and techniques in addition to, or instead of, certain of those timings and techniques discussed in conjunction with the FIG. 4 embodiment.

In the FIG. 4 drawing, the data transfer cycle is shown starting at time 418 and ending at time 430. In the FIG. 4 drawing, a setup interval 414 occurs between time 418 and time 422. During the FIG. 4 setup interval 414, memory subsystem 242 (FIG. 2) performs certain preparatory actions for performing a data transfer operation 426. In the FIG. 4 drawing, transfer operation 426 occurs between time 422 and time 430. In certain embodiments, during setup interval 414, memory subsystem 242 may provide appropriate address information for the transfer operation 426, and may also transfer the addressed data from a storage memory location to an internal data register.

In the FIG. 4 embodiment, setup interval 414 is approximately 25 microseconds, and transfer operation 426 is approximately 25 microseconds. In other embodiments, any other effective durations are also contemplated. The relatively lengthy setup interval 414 therefore accounts for approximately one-half of the total data transfer cycle. The extended setup interval 414 is one of the major contributing factors to the slow transfer speeds of flash memory 514 (FIG. 4). Certain novel improvements to remedy the foregoing slow data transfer speeds are further discussed below in conjunction with FIGS. 5-9.

Referring now to FIG. 5, a block diagram for one embodiment of the FIG. 2 memory subsystem 242 is shown, in accordance with the present invention. In alternate embodiments, memory subsystem 242 may be implemented using components and configurations in addition to, or instead of, certain of those components and configurations discussed in conjunction with the FIG. 5 embodiment.

In the FIG. 5 embodiment, even memory channel 222(a) and odd memory channel 222(b) are implemented and function in a same or similar manner to store respective even and odd pages 318 (FIG. 3) of data. In other words, transfer controller 218 alternates between storing even pages 318 of data into even memory 514(a) and storing odd pages 318 of data into odd memory 514(b). In accordance with the present invention, transfer controller 218 may advantageously perform concurrent or temporally-overlapping data transfer operations with the multiple memory channels 222 to significantly increase data transfer speeds for electronic device 114 (FIG. 2).

In the FIG. 5 embodiment, even memory 514(a) and odd memory 514(b) may be implemented as conventional or enhanced versions of flash memory 514 (FIG. 3). In alternate embodiments, other types of memory devices are also contemplated. In the FIG. 5 embodiment, transfer controller 218 or another appropriate entity provides data transfer control signals to controller logic 526 of the respective memory channels 222. For example, the transfer control signals may include, but are not limited to, a chip enable signal (CE#), a command latch enable (CLE), an address latch enable (ALE), a write enable (WE#), a write protect signal (WP#), and a read enable (RE#).

In the FIG. 5 embodiment, flash memories 514 may communicate with transfer controller 218 through respective page registers 518, input-output (IO) controls 522, and ports 530 to transfer appropriate page data. Transfer controller 218 may similarly communicate with output FIFO 226 to transfer the data in or out of electronic device 114. In the FIG. 5 embodiment, output FIFO 226 may be controlled with a FIFO write clock (CkFw) 546, or a FIFO read clock (CkFr) 550. Output FIFO 226 may provide several different feedback signals to transfer controller 218, including an almost-full (ALF) signal, an almost-empty (ALE) signal, and a half-full (FHF) signal.

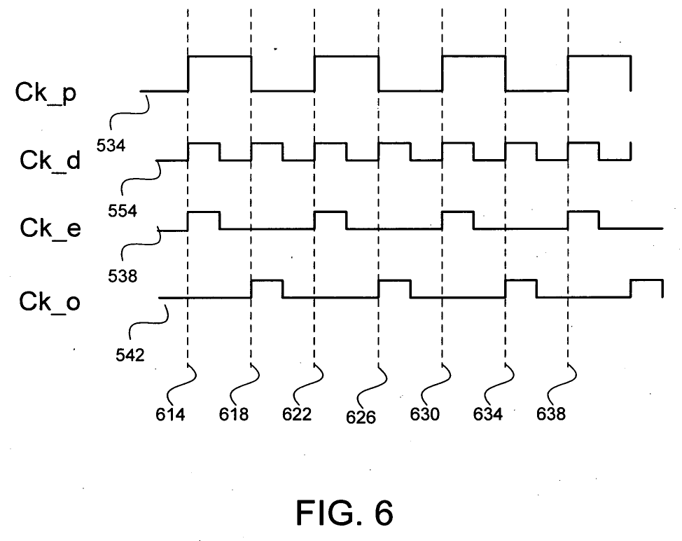

In the FIG. 5 embodiment, transfer controller 218 or other appropriate entity may generate appropriate clock signals to control the operation of memory subassembly 242. For example, a base clock signal (Ck_p) 534 is provided as a read-enable signal to memory channels 222. The base clock signal 534 may be subdivided into a divided clock signal (Ck_d) 554 based upon the number of memory channels 222 in memory subsystem 242. Then, individual channel clocks may be derived from the divided clock signal 554 to gate transfer data through respective ports 530. In the FIG. 5 embodiment, the channel clocks include an even channel clock (Ck_e) 538 and an odd channel clock (Ck_o) 542. The implementation and utilization of the FIG. 5 clock signals are further discussed below in conjunction with FIGS. 6-9.

Referring now to FIG. 6, a timing diagram for the FIG. 5 clock signals is shown, in accordance with one embodiment of the present invention. The FIG. 6 example is presented for purposes of illustration, and in alternate embodiments, the present invention may utilize clock signals with timings and relationships in addition to, or instead of, certain of those timings and relationships discussed in conjunction with the FIG. 6 embodiment.

In the FIG. 6 embodiment, transfer controller 218 or other appropriate entity may generate appropriate clock signals to control the operation of memory subassembly 242 (FIG. 5). For example, a base clock signal (Ck_p) 534 is provided as a read-enable signal to memory channels 222. For purposes of illustration, let us assume that base clock signal 534 has a frequency of 20.5 MHz. As shown in the FIG. 6 timing diagram, the base clock signal 534 may be subdivided into a divided clock signal (Ck_d) 554 based upon the number of memory channels 222 in memory subsystem 242.

For example, since the FIG. 5 memory subsystem 242 has two memory channels 222, the frequency of the divided clock signal 554 may be obtained by multiplying the frequency of the base clock signal 534 by the number of memory channels 222 (multiply by 2). In the FIG. 6 embodiment, the divided clock signal 554 therefore has a frequency that is 41.0 MHz (double the frequency of base clock signal 534). Divided clock signals 554 for memory subsystems 242 with any desired number of memory channels 222 may similarly be calculated according to the following formula:

Divided Clock Frequency=N*Base Clock Frequency

where “N” is the total number of memory channels 222 implemented in a given memory subsystem 242.

In the FIG. 6 embodiment, individual channel clocks may then be derived from the divided clock signal 554 to gate transfer data through respective ports 530 of memory subsystem 242. The respective channel clocks are preferably aligned with the corresponding appropriate leading edges of divided clock signal 554 (at times 614, 618, 622, 626, 630, 634, and 638, etc.) In the FIG. 6 embodiment, since the FIG. 5 memory subsystem 242 has only two memory channels 222, the channel clocks include an even channel clock (Ck_e) 538 and an odd channel clock (Ck_o) 542.

The first pulse of even channel clock signal 538 is aligned with the first pulse of divided clock signal 554 (at time 614), and then additional clock pulses occur every second pulse of divided clock signal 554 (at times 622, 630, and 638, etc.). The odd channel clock signal 542 is delayed with respect to the even clock signal 538 by one cycle of divided clock signal 554 with pulses occurring at times 618, 626, and 634, etc. In the FIG. 6 embodiment, memory subsystem 242 thus utilizes the individual channel clock signals 538 and 542 to alternately trigger respective data transfers for even memory channel 222(a) and odd memory channel 222(b) of the FIG. 5 memory subsystem 242.

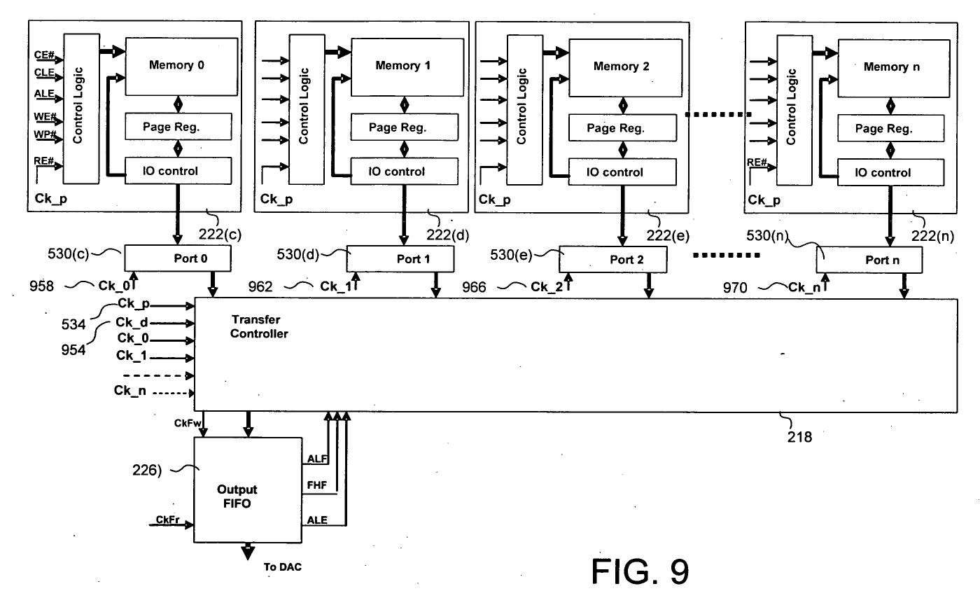

In embodiments with more than two memory channels 222, additional channel clock signals may be generated in a same or similar manner to that disclosed in the FIG. 6 embodiment. Each successive channel clock signal would then be delayed by an additional cycle of the divided clock signal. For example, if there were four memory channels, then a first channel clock pulse for the first memory channel would be aligned with the first clock pulse of the divided clock signal. A second channel clock pulse for the second memory channel would be aligned with the second clock pulse of the divided clock signal. A third channel clock pulse for the third memory channel would be aligned with the third clock pulse of the divided clock signal. A fourth channel clock pulse for the fourth memory channel would be aligned with the fourth clock pulse of the divided clock signal. On the fifth clock pulse of the divided clock signal, another first channel clock pulse would be generated, and the process would continue in the same manner throughout the corresponding data transfer operation. The generation and utilization of individual channel clock signals are further discussed below in conjunction with FIG. 9.

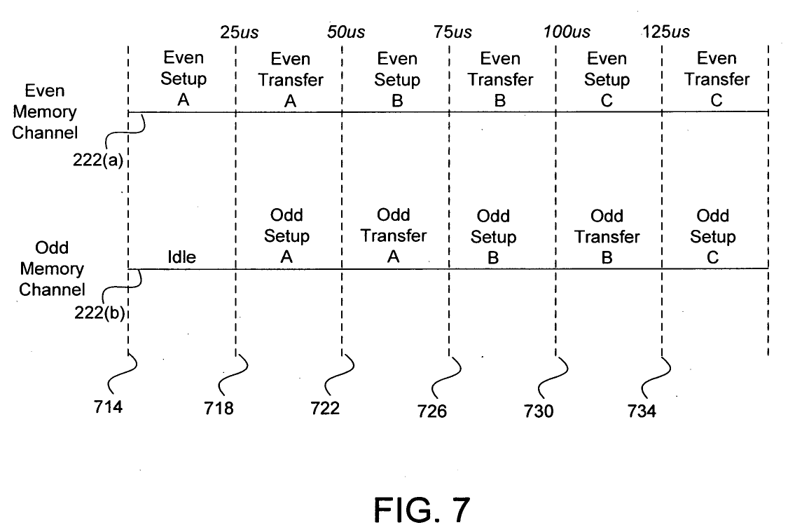

Referring now to FIG. 7, a timing diagram illustrating the operation of the FIG. 5 memory architecture 242 is shown, in accordance with one embodiment of the present invention. The FIG. 7 example is presented for purposes of illustration, and in alternate embodiments, the present invention may utilize timings and techniques in addition to, or instead of, certain of those timings and techniques discussed in conjunction with the FIG. 7 embodiment.

In the FIG. 7 diagram, a series of data transfer cycles for even memory channel 222(a) and odd memory channel 222(b) (FIG. 5) are shown. As discussed above in conjunction with FIG. 4, each data transfer cycle includes a setup interval (approximate duration=25 microseconds), immediately followed by a corresponding transfer operation (approximate duration=25 microseconds). In the FIG. 7 example, in response to an even channel clock pulse 538 (FIG. 6), an even setup interval A occurs between time 714 and time 718 to setup an even transfer operation A for even memory channel 222(a). Then, between time 718 and time 722, an even transfer operation A occurs to complete the corresponding even data transfer cycle A. Similarly, between time 722 and time 730, an even data transfer cycle B occurs, and at time 730, and a similar even data transfer cycle C begins.

In addition, the FIG. 7 example, in response to an odd channel clock pulse 542 (FIG. 6), an odd setup interval A occurs between time 718 and time 722 to setup an odd transfer operation A for odd memory channel 222(b). In accordance with the present invention, the odd data transfer cycle A thus begins one-half of a data transfer cycle later than the corresponding even data transfer cycle A. Memory subsystem 242 therefore concurrently operates the multiple memory channels 222 in parallel to significantly increase data transfer speeds of corresponding data transfer operations in electronic device 114.

In the FIG. 7 example, between time 722 and time 726, an odd transfer operation A occurs to complete the corresponding odd data transfer cycle A. Similarly, between time 726 and time 734, an odd data transfer cycle B occurs, and at time 734, and a similar odd data transfer cycle C begins. The FIG. 7 example is provided with symmetrical durations (25 microseconds) for each of the setup intervals and the corresponding transfer operations. However, in various other embodiments, any effective and desired durations (either matching or unmatched) are equally possible for the setup intervals and/or transfer operations. The present invention therefore provides an improved multiple-channel memory architecture in which the individual memory channels 222 may be concurrently utilized in either a simultaneous or an overlapping staggered manner to significantly increase data transfer speeds of corresponding data transfer operations in electronic device 114.

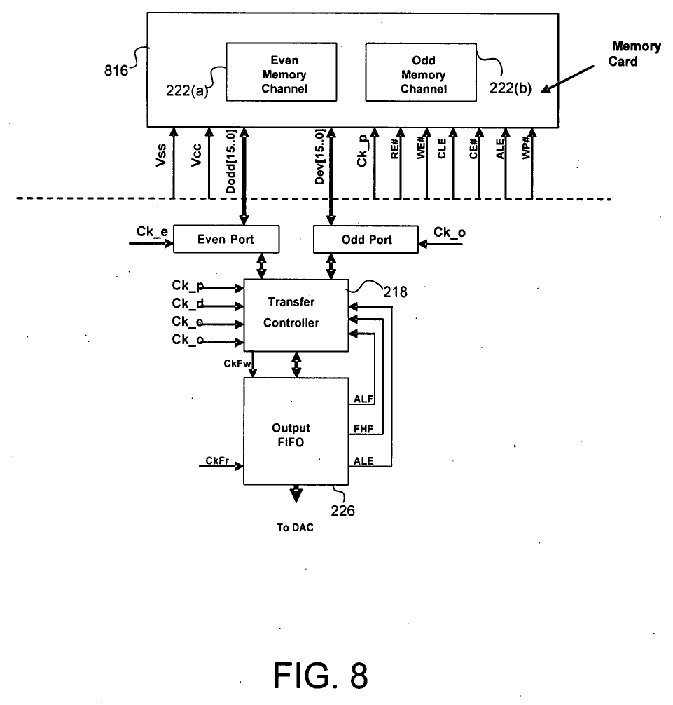

Referring now to FIG. 8, a block diagram for an alternate embodiment of the FIG. 2 memory subsystem 242 is shown, in accordance with the present invention. In alternate embodiments, memory subsystem 242 may be implemented using components and configurations in addition to, or instead of, certain of those components and configurations discussed in conjunction with the FIG. 8 embodiment.

In the FIG. 8 embodiment, memory subsystem 242 includes elements, signals, and functionalities that are the same or similar to those elements, signals, and functionalities discussed above in conjunction with FIG. 5. However, the FIG. 8 embodiment has even memory channel 222(a) and odd memory channel 222(b) implemented as part of a memory card 816 that may be easily inserted or removed from memory subsystem 242 to facilitate updating the memory channels 222 or possibly archiving data stored in a given memory card 816.

Referring now to FIG. 9, a block diagram for another embodiment of the FIG. 2 memory subsystem 242 is shown, in accordance with the present invention. In alternate embodiments, memory subsystem 242 may be implemented using components and configurations in addition to, or instead of, certain of those components and configurations discussed in conjunction with the FIG. 9 embodiment.

In the FIG. 9 embodiment, memory subsystem 242 includes elements, signals, and functionalities that are the same or similar to those elements, signals, and functionalities discussed above in conjunction with FIG. 5. However, the FIG. 9 embodiment includes a greater selectable number of memory channels 222 (a total of “n” channels) than the two even and odd memory channels disclosed in the FIG. 5 embodiment. In accordance with the FIG. 9 embodiment, any desired number of memory channels 222 may be utilized. For example, in certain embodiments, memory subsystem 242 may include approximately ten memory channels 222.

In the FIG. 9 embodiment, a memory channel 0 (222(c)), a memory channel 1 (222(d)), a memory channel 2 (222(e)), through a memory channel n (222(n)) are shown. Each memory channel communicates with transfer controller 218 through a corresponding respective port 530. For example, memory channel 0 (222(c)) utilizes port 0 (530(c)), memory channel 1 (222(d)) utilizes port 1 (530(d)), memory channel 2 (222(e)) utilizes port 2 (530(e)), and memory channel n (222(n)) utilizes port n (530(n)). In the FIG. 9 embodiment, transfer controller 218 sequentially stores electronic data into memory channels 222 on a page-by-page basis. For example, a first page 318 (FIG. 3) may be stored into memory channel 0 (222(c)), a second page 318 may be stored into memory channel 1 (222(d)), a third page 318 may be stored into memory channel 2 (222(e)), etc.

In the FIG. 9 embodiment, similar to the clock arrangement in the FIG. 5 embodiment, each of the foregoing ports 530 receives a corresponding individual channel clock signal. For example, a channel clock 0 (Ck_0) 958 is provided to port 0 (530(c), a channel clock 1 (Ck_1) 962 is provided to port 1 (530(d)), a channel clock 2 (Ck_2) 966 is provided to port 2 (530(e)), and a channel clock n (Ck-0) 970 is provided to port n (530(n)). As discussed above in conjunction with FIGS. 5-6, the individual channel clocks are derived from a divided clock signal (Ck_d) 954, which in turn is derived from a base clock signal (Ck_p) 534.

In the FIG. 9 embodiment, base clock signal (Ck_p) 534 is provided as a read-enable signal to memory channels 222. For purposes of illustration, let us assume that base clock signal 534 has a frequency of 20.5 MHz. The base clock signal 534 may then be subdivided into the divided clock signal (Ck_d) 954 based upon the number of memory channels 222 in memory subsystem 242. For example, since the FIG. 9 memory subsystem 242 has “n” memory channels 222, the frequency of the divided clock signal 954 may be obtained by multiplying the frequency of the base clock signal 534 by the number of memory channels 222 (multiply by “n”). In the FIG. 9 embodiment, the divided clock signal 954 therefore has a frequency that is 20.5 MHz multiplied by the number “n”.

In the FIG. 9 embodiment, the individual channel clocks may be derived from the divided clock signal 954 to gate transfer data through respective ports 530 of memory subsystem 242. The respective channel clock pulses are preferably aligned with the corresponding appropriate leading edges of the divided clock signal 954. In the FIG. 9 embodiment, each successive channel clock signal is delayed by one cycle of the divided clock signal 954. In the FIG. 9 embodiment, memory subsystem 242 thus utilizes the individual channel clock signals to successively trigger respective concurrent data transfers from the memory channels 222 of the FIG. 9 memory subsystem 242.

In the FIG. 9 embodiment, each successive channel clock signal is delayed by an additional cycle of the divided clock signal 954. For example, a channel clock pulse 958 for the memory channel 0 (222(c) is aligned with the first clock pulse of the divided clock signal 954. A channel clock pulse 962 for the memory channel 1 (222(d)) is aligned with the second clock pulse of the divided clock signal 954. A channel clock pulse 966 for the memory channel 2 (222(e)) is aligned with the third clock pulse of the divided clock signal 954. The foregoing sequential delaying of the channel clock signals then continues in the same manner through to channel clock signal 970. The FIG. 9 embodiment therefore provides an improved multiple-channel memory architecture in which the individual memory channels 222 may be concurrently utilized to significantly increase data transfer speeds of corresponding data transfer operations in electronic device 114. The present invention thus provides an improved system and method for effectively implementing a multiple-channel memory architecture.

The invention has been explained above with reference to certain embodiments. Other embodiments will be apparent to those skilled in the art in light of this disclosure. For example, the present invention may readily be implemented using configurations and techniques other than those described in the embodiments above. Additionally, the present invention may effectively be used in conjunction with systems other than those described above. Therefore, these and other variations upon the discussed embodiments are intended to be covered by the present invention, which is limited only by the appended claims.

What is claimed is:

1. A system for implementing a multiple-channel memory architecture, comprising:
memory channels that are configured to store electronic data, said memory channels including at least a first memory channel and a second memory channel; and
a transfer controller that communicates with said memory channels to perform data transfer operations that occur concurrently to transfer said electronic data.

2. The system of claim 1 wherein said memory channels are implemented to include non-volatile flash memory devices.

3. The system of claim 1 wherein said memory channels and said transfer controller are a part of a memory subsystem for a data acquisition/playback machine that is controlled by a central-processing unit.

4. The system of claim 3 wherein said data acquisition/playback machine receives radio-frequency television broadcasting data that is subsequently provided to a data diagnostics system for analysis.

5. The system of claim 3 wherein said memory subsystem includes an output FIFO memory, said transfer controller, and ports that each correspond to a respective one of said memory channels.

6. The system of claim 1 wherein each of said memory channels includes control logic, an input-output control, a page register, and a flash memory.

7. The system of claim 6 wherein said transfer controller provides control signals to said control logic, said control signals including a channel enable signal, a channel latch enable, an address latch enable, a write enable, a write protect signal, and a read enable.

8. The system of claim 1 wherein said transfer controller generates memory clock signals to trigger said data transfer operations, said memory clock signals including a base clock signal and a divided clock signal that is related to said base clock signal based upon a total number “n” of said memory channels.

9. The system of claim 8 wherein said memory clock signals further include a series of channel clock signals that are based upon said divided clock signal,

10. The system of claim 9 wherein each of said channel clock signals has a different phase relationship with respect to said divided clock signal, each of said channel clock signals controlling said data transfer operations for said electronic data from different respective ones of said memory channels.

11. The system of claim 5 wherein said output FIFO memory provides an almost-full signal, an almost-empty signal, and a half-full signal to said transfer controller.

12. The system of claim 1 wherein said data transfer operations include a series of data transfer cycles with setup intervals and corresponding subsequent transfer operations, said transfer controller compensating for transfer delays caused by said setup intervals by performing said data transfer operations from respective ones of said memory channels in a temporally-overlapping manner.

13. The system of claim 1 wherein said transfer controller performs said data transfer operations to transfer said electronic data either to or from said memory channels on a rotating page-by-page basis.

14. The system of claim 1 wherein said memory channels include one or more additional memory channels in addition to said first memory channel and said second memory channel, said transfer controller communicating with each of said additional memory channels through a respective additional port that is controlled by a respective additional channel clock signal.

15. The system of claim 1 wherein said transfer controller provides a base clock signal that has base clock pulses occurring at a base clock frequency.

16. The system of claim 15 wherein said transfer controller provides a divided clock signal that has divided clock pulses occurring at a divided clock frequency that is defined with a formula:
DCF=N*BCF
Where said “N” is a total number of said memory channels, said DCF is said divided clock frequency, and said BCF is said base clock frequency.

17. The system of claim 16 wherein said transfer controller provides individual channel clock signals to trigger said data transfer operations from corresponding respective ones of said memory channels, sequential ones of said individual clock signals being successively delayed by one clock cycle of said divided clock signal so that said data transfer operations from said corresponding respective ones of said memory channels occur in a temporally-offset and overlapping manner.

18. The system of claim 1 wherein said transfer controller performs said data transfer operations as memory read operations to read said electronic data out of said memory channels.

19. The system of claim 1 wherein said transfer controller performs said data transfer operations as memory write operations to write said electronic data into said memory channels.

20. The system of claim 1 wherein said memory channels are implemented together in a discrete memory card that is physically connectable/disconnectable with respect to a memory subsystem that incorporates said transfer controller.

21. A method for implementing a multiple-channel memory architecture, comprising:
configuring memory channels to store electronic data, said memory channels including at least a first memory channel and a second memory channel; and
communicating with said memory channels by utilizing a transfer controller to perform data transfer operations concurrently to transfer said electronic data.

22. The method of claim 21 wherein said memory channels are implemented to include non-volatile flash memory devices.

23. The method of claim 21 wherein said memory channels and said transfer controller are a part of a memory subsystem for a data acquisition/playback machine that is controlled by a central-processing unit.

24. The method of claim 23 wherein said data acquisition/playback machine receives radio-frequency television broadcasting data that is subsequently provided to a data diagnostics system for analysis.

25. The method of claim 23 wherein said memory subsystem includes an output FIFO memory, said transfer controller, and ports that each correspond to a respective one of said memory channels.

26. The method of claim 21 wherein each of said memory channels includes control logic, an input-output control, a page register, and a flash memory.

27. The method of claim 26 wherein said transfer controller provides control signals to said control logic, said control signals including a channel enable signal, a channel latch enable, an address latch enable, a write enable, a write protect signal, and a read enable.

28. The method of claim 21 wherein said transfer controller generates memory clock signals to trigger said data transfer operations, said memory clock signals including a base clock signal and a divided clock signal that is related to said base clock signal based upon a total number “n” of said memory channels.

29. The method of claim 28 wherein said memory clock signals further include a series of channel clock signals that are based upon said divided clock signal,

30. The method of claim 29 wherein each of said channel clock signals has a different phase relationship with respect to said divided clock signal, each of said channel clock signals controlling said data transfer operations for said electronic data from different respective ones of said memory channels.

31. The method of claim 25 wherein said output FIFO memory provides an almost-full signal, an almost-empty signal, and a half-full signal to said transfer controller.

32. The method of claim 21 wherein said data transfer operations include a series of data transfer cycles with setup intervals and corresponding subsequent transfer operations, said transfer controller compensating for transfer delays caused by said setup intervals by performing said data transfer operations from respective ones of said memory channels in a temporally-overlapping manner.

33. The method of claim 21 wherein said transfer controller performs said data transfer operations to transfer said electronic data either to or from said memory channels on a rotating page-by-page basis.

34. The method of claim 21 wherein said memory channels include one or more additional memory channels in addition to said first memory channel and said second memory channel, said transfer controller communicating with each of said additional memory channels through a respective additional port that is controlled by a respective additional channel clock signal.

35. The method of claim 21 wherein said transfer controller provides a base clock signal that has base clock pulses occurring at a base clock frequency.

36. The method of claim 15 wherein said transfer controller provides a divided clock signal that has divided clock pulses occurring at a divided clock frequency that is defined with a formula:
DCF=N*BCF
where said “N” is a total number of said memory channels, said DCF is said divided clock frequency, and said BCF is said base clock frequency.

37. The method of claim 16 wherein said transfer controller provides individual channel clock signals to trigger said data transfer operations from corresponding respective ones of said memory channels, sequential ones of said individual clock signals being successively delayed by one clock cycle of said divided clock signal so that said data transfer operations from said corresponding respective ones of said memory channels occur in a temporally-offset and overlapping manner.

38. The method of claim 21 wherein said transfer controller performs said data transfer operations as memory read operations to read said electronic data out of said memory channels.

39. The method of claim 21 wherein said transfer controller performs said data transfer operations as memory write operations to write said electronic data into said memory channels.

40. The method of claim 21 wherein said memory channels are implemented together in a discrete memory card that is physically connectable/disconnectable with respect to a memory subsystem that incorporates said transfer controller.

41. A system for implementing a multiple-channel memory architecture, comprising:
means for storing electronic data, said means for storing electronic data including at least a first memory channel and a second memory channel; and
means for communicating with said means for storing to perform data transfer operations concurrently to transfer said electronic data.

42. A system for implementing a multiple-channel memory architecture, comprising:
a plurality of memory channels that are configured to store electronic data, said memory channels being each implemented to include a non-volatile flash memory device; and
a transfer controller that communicates with said memory channels to perform data transfer operations that occur concurrently to transfer said electronic data, said transfer controller generating individual channel clock signals to said memory channels for triggering said data transfer operations, said data transfer operations occurring in an overlapping temporal sequence.
